(19) United States
(12) Patent Application Publication
(10) Pub. No.: US 2002/0079268 A1
(43) Pub. Date: Jun. 27, 2002

(54) Process for preparing a fermentation medium from a renewable raw material

(76) Inventors: Jean-Jacques Caboche, Drouvin-Les-Marais (FR); Pierrick Duflot, La Couture (FR); Catherine Fouache, Sailly/Labourse (FR); Laurent Seigueilha, Lambersart (FR)

Correspondence Address: HENDERSON & STURM LLP, 1213 MIDLAND BUILDING, 206 SIXTH AVENUE, DES MOINES, IA, 50309-4076, US

(21) Appl. No.: 09/942,069

(22) Filed: Aug. 29, 2001

(30) Foreign Application Priority Data
Nov. 9, 2000 (FR) 0014398

(51) Int. Cl. C02F 9/00

(52) U.S. Cl. 210/631

(57) ABSTRACT

The invention relates to a process for preparing a fermentation medium for producing high-purity metabolites from a renewable raw material, characterised in that it consists of optionally treating said renewable raw material to enrich it with carbon or nitrogen sources which can be directly assimilated by micro-organisms and to eliminate insoluble impurities, using a technique chosen from the group consisting of nanofiltration and electrodialysis, alone or in combination, to eliminate low molecular weight impurities from said renewable raw material without degrading its concentration of carbon sources which can be directly assimilated, treating the raw material from which the low molecular weight impurities have been eliminated in this way to top it up with nitrogen or carbon sources which can be directly assimilated by the micro-organisms, and recovering the fermentation medium obtained in this way.

The present invention relates to a particular process for preparing a fermentation medium from a renewable raw material.

To be more precise, the present invention relates to a particular process for processing a renewable raw material so that it can be used directly in fermentation to produce high-purity metabolites without it being necessary to employ many long and costly purification steps to isolate the metabolites.

In the context of the present invention, the expression “renewable raw material” means waste material from the foodstuffs industries, which is cheap, unrefined, generally not toxic, and rich in sources of nitrogen and carbon.

In the context of the invention, the term “metabolites” means products of transformation by fermentation of carbon sources that can be assimilated directly by micro-organisms. They are advantageously metabolites chosen from the group consisting of organic acids, vitamins, amino acids and antibiotics, and are preferably organic acids such as L-lactic acid.

It is generally accepted that the choice of said renewable raw material is based on its availability, cost and potential for high productivity.

It is also accepted that a fermentation medium must contain not only a source of carbon but also a source of nitrogen, to which minerals and organic salts are added.

The “carbon source” can be obtained from renewable raw materials such as molasses, hydrolysates of starch from wheat, corn, rice, cassava or potatoes, but the “carbon sources which can be directly assimilated” are refined or purified sugars from said carbon sources, such as glucose, fructose, maltose, saccharose, lactose and dextrins.

Examples of “nitrogen sources” or protein-based nutrients are yeast extracts, corn steep liquor, non-denatured milk, molasses proteins, meat extracts or soya flour. However, it is often preferred to use yeast extracts as nitrogen sources and also as additional sources of vitamins and minerals.

The fermentation medium consisting of a “carbon source which can be directly assimilated”, i.e. glucose or saccharose, and of yeast extracts, can be used basically for many kinds of fermentation process, such as fermentation for producing organic acids, such as lactic, propionic, gluconic, citric, etc. acids, essential amino acids such as lysin, antibiotics or any other metabolite of industrial interest.

These media are also suitable for producing biomass (for example for preparing lactic ferments).

However, it is accepted that these media have the drawback that it is not possible to extrapolate from them to production on an industrial scale of the same economically viable metabolites (because of the difficulty of providing media that are standardised in terms of their composition, and because of additional costs arising from subsequent purification steps).

To reduce costs, the choice has therefore been made to use fermentation media in which one of the nitrogen or hydrocarbon sources is provided by a cheap raw material and the other component of the fermentation medium is refined or purified.

For producing an organic acid such as lactic acid, for example:

U.S. Pat. No. 5,416,020 describes a process for producing L-lactic acid from whey and permeate of whey, but yeast extract is also added in the presence of divalent manganese, with a mutant strain of Lactobacillus delbrueckii sub. bulgaricus ATCC 55163, which essentially produces L-lactic acid.

Permeate of whey does contain 75 wt. % to 80 wt. % lactose, but does not contain any large proteins any more. It is therefore deficient in nitrogen sources, which are essential for the growth of micro-organisms. Whence the need to add yeast extracts. The whey added essentially contains of the order of 65 wt. % to 75 wt. % lactose.

The yeast extract then supplies the fermentation medium with the nutrients that are not adequately provided by the permeates of whey or the whey itself.

U.S. Pat. No. 4,467,034 shows that it is possible to produce lactic acid from whey as the raw material, using a new strain Lactobacillus bulgaricus DSM 2129.

However, the whey must still be provided with an additional source of nitrogen, i.e. meat extract, corn steep liquor or soya flour, and with vitamins and mineral salts.

Although using these fermentation media under the above conditions slightly reduces the cost of the raw material used, it requires judiciously selected combinations conforming to the nitrogen/carbon ratio, plus the additives necessary for efficiency and productivity.

Furthermore, these “reconstituted” media are not suited to the production of a high-purity metabolite such as lactic acid, for example, which must then be isolated and purified by any of the many standard techniques, such as membrane separation, ion exchange, extraction by solvents, electrodialysis and precipitation of lactate salts.

In relation to preparing optically pure lactic acid with Lactobacillus, U.S. Pat. No. 4,769,329 explains that to promote growth of the micro-organisms it is necessary to add a number of substances that they cannot produce themselves, for example biotin, thiamine, nicotinic acid, pyridoxamine, p-aminobenzoic acid, pantothenic acid and cyanocobalamine.

The above components must be added in the form of complex media, such as the MRS medium developed by MAN, ROGOSA and SHARPE, although this process cannot be used to produce lactic acid industrially (because of the excessive cost and the difficulty of obtaining media of standard composition).

Complex media such as sugar beet molasses or corn steep liquor, although stimulating the growth of bacteria, cannot be used to prepare optically pure lactic acid because they themselves contain a substantial quantity of racemic lactic acid.

Optically pure lactic can be obtained from said racemic mixture only by precipitating and recrystallising salts of D- and L-lactic acids, which is complex and costly.

For obtaining an optically pure lactic acid, U.S. Pat. No. 4,769,329 recommends using baker's yeast as a source of vitamins, nitrogen, sugars and trace mineral elements. The medium also contains glucose, saccharose or lactose as a carbon source which can be directly assimilated and can be converted into lactic acid.

It is necessary to revert to a refined and therefore very costly medium for producing a high-purity metabolite, in this instance optically active high-purity lactic acid.

A number of solutions have been proposed that attempt to solve the problems of the prior art previously cited.

The first solution is to use micro-organisms that are particularly resistant to certain fermentation conditions or using a cocktail of micro-organisms. The second is to pretreat the renewable raw material. These two solutions can also be combined.

In U.S. Pat. No. 4,963,486, for example, using corn as a renewable raw material is limited to its association with Rhizopus oryzae, which has the unique capacity of contributing both the enzymes for saccharifying the raw material and the enzymes for fermenting it to produce L-lactic acid.

Fermentation is effected at a temperature in the range from 20° C. to 40° C., preferably at 30° C. A neutralisation agent must be added to stabilise the pH. Calcium carbonate is preferably chosen because it has the particular feature of forming a calcium lactate that precipitates at 4° C. and enables selective recovery of a high-purity lactic acid.

The method of purifying lactic acid is not optimised, however, because it generates large quantities of gypsum, which is harmful to the environment.

U.S. Pat. No. 5,464,760 points out that the abundant supply of food waste products, which are generally non-toxic and can be fermented directly, provides an abundant and concentrated carbon and nitrogen source for various aerobic and anaerobic bacteria. Lactic acid can then be produced directly from permeate of whey, sugar cane or sugar beet by various lactic bacteria of the Lactobacillus type with a high yield, by hydrolysing starch from corn, potatoes or rice, followed by bioconversion with said micro-organisms.

However, it is necessary to use mixed cultures of five strains of lactic bacteria and to carry out saccharification and fermentation.

The starch is partly liquefied and then subjected to particular conditions of pH and temperature that enable the glucoamylase to be introduced at the same time as the lactic bacteria.

This solution is not recommended, however, because it is recognised that the hydrolysed starch, such as hydrolysates of potato produced from potato waste or glucose syrup available from any starch manufacturer, normally contains up to 5% of “sugary impurities”, i.e. pentoses, maltose and oligosaccharides, which remain unused at the end of fermentation or are converted into other by-products, such as acetic acid, which cause problems in subsequent purification steps.

It is still necessary to add a further nutrient based on organic and mineral salts and yeast extract.

According to MOTOYOSHI et al. in Appl. Environ. Microbiol. 1986, 52(2), 314-319, it is even necessary to remove the lactic acid as and when it is formed in the fermentation medium by continuous electrodialysis, to prevent unbalancing the population of introduced micro-organisms.

Similarly, TIWARI et al., in Zbl. Bakt. II. Abt. Bd., 134, 544-546 (1970), describe the use of mixed cultures of Lactobacillus bulgaricus, L. casei with or without L. delbrueckii with dilute molasses to produce lactic acid.

This technique is used in an attempt to increase production yield of lactic acid from molasses.

However, the yield does not exceed 57.9% at best, and the strains usually interfere with each other in terms of their respective production capacity.

As for the second solution, which consists of particular treatment of the renewable raw material, one object of the invention that constitutes the subject matter of U.S. Pat. No. 3,429,777 is to exploit the remarkable property of magnesium lactate of crystallising spontaneously from a fermentation medium containing molasses in a state of sufficient purity to enable lactic acid of high purity to be produced from said magnesium lactate.

The process using magnesium therefore seems less complicated and less costly than those usually described in the literature, such as using calcium, for example. However, it nevertheless remains true that the purity of the magnesium lactate in the “sugary raw liquor” varies as a function of the nature and the quality of the renewable raw material used, even if it is of better quality than calcium lactate.

Finally, the third solution consists of allowing both for the micro-organisms and for the treatment of the renewable raw material introduced into the fermentation medium.

For example, starch has often been recommended as a cheap carbon source, but not all micro-organisms can metabolise it, whereas most micro-organisms can metabolise glucose.

Thus the process described in FR 2,635,334 carries out lactic fermentation in the presence of at least one saccharifying amylolytic enzyme, but there is no disclosure of any means of eliminating impurities from the fermentation medium treated in this way.

MANHEIM and CHERYAN in JAOCSS, 69, 12, 1992, describe the controlled use of hydrolysis enzymes and the technology of the membranes for isolating specific fractions of wheat gluten. These techniques can also be extrapolated to soya.

To stimulate greater use in human foods of proteins from wheat gluten flour, the research team developed the use of proteases to modify some of their functional properties.

However, there is no description or suggestion of using these proteins in the fermentation industries, or to prepare easily purified metabolites from said fermentation media.

Other strategies used have not modified the fermentation medium excessively, and instead ensure the growth of production strains to accelerate the rate of microbial production and the resistance to high concentrations of lactic acid.

The conventional tools for this are biomass recycling and immobilised cells.

In this case the lactic acid must be recovered as and when it is produced, to prevent it inhibiting bacterial growth and production.

Various techniques coupled with fermentation have been used to remove the lactic acid continuously from the fermentation medium, i.e. dialysis, electrodialysis, ion exchange resins, two-particle fluidised bed bioreactors, reverse osmosis and liquid-liquid extraction.

However, the cost of the medium then represents more than 30% of the total production cost. Cheap nutrients are therefore indispensable.

It is therefore clear that many attempts have been made to reduce the cost of producing high-purity metabolites such as lactic acid.

However, it follows from the whole of the foregoing discussion that there is an unsatisfied need for a simple and efficient process for producing by fermentation metabolites that are easy to purify without using many complex and costly process steps either to prepare the fermentation medium or to recover said metabolite from the fermentation medium.

It is therefore necessary to develop fermentation conditions that eliminate all the impurities that usually accompany the production of the economically viable metabolite and, most importantly, complicate its purification.

In the case of lactic acid, this means racemic mixtures of D- and L-lactic acids already present in the starting renewable raw material, and also all the “sugary impurities” mentioned above, which clog the medium at the end of fermentation.

Keen to develop a process that constitutes a better response to practical constraints than existing methods, the applicant company has found that this objective can be achieved by a process consisting of treating the renewable raw material by a combination of enzymatic steps in order to release from it the carbon and nitrogen sources which can be directly assimilated by the micro-organisms, and specific steps of separation by microfiltration and nanofiltration or electrodialysis in order to eliminate from the medium all components likely to degrade the quality of the metabolite to be isolated and that could impede and/or complicate its subsequent purification.

The process developed by the applicant company can then be chosen with advantage for the production of any economically viable metabolite, and preferably of metabolites chosen from the group consisting of organic acids, vitamins, amino acids and antibiotics.

The process according to the invention is particularly suitable for preparing a metabolite chosen from organic acids, preferably L-lactic acid.

The process developed by the applicant company can equally be chosen for producing populations of economically viable micro-organisms, as it provides a fermentation medium free of all impurities likely to pollute said populations.

The process in accordance with the applicant company's invention for preparing a fermentation medium for producing high-purity metabolites from a renewable raw material is characterised in that it consists of:

a) optionally treating said renewable raw material to enrich it with carbon or nitrogen sources which can be directly assimilated by micro-organisms and to eliminate insoluble impurities,

b) using a technique chosen from the group consisting of nanofiltration and electrodialysis, alone or in combination, to eliminate low molecular weight impurities from said renewable raw material without degrading its concentration of carbon sources which can be directly assimilated,

c) treating the raw material from which the low molecular weight impurities have been eliminated in this way to top it up with nitrogen or carbon sources which can be directly assimilated by the micro-organisms, and

d) recovering the fermentation medium obtained in this way.

The first step of the process according to the invention optionally consists of treating the renewable raw material to enrich it with nitrogen or carbon sources which can be directly assimilated by the micro-organisms and to eliminate insoluble impurities from it.

The above treatments are adapted as a function of the nature of the renewable raw material.

In a first embodiment of the process according to the invention, a renewable raw material is chosen from the group consisting of by-products of manufacture of starch, such as by-products of manufacture of starch from wheat, corn, cassava, potato, or by-products of the processing barley, peas, etc.

For example, by-products of the manufacture of wheat starch are advantageously chosen for producing L-lactic acid, more particularly wheat solubles, or by-products of the manufacture of corn starch, more particularly corn steep liquor.

Here the renewable raw materials contain starch as a source of residual glucose or carbon and proteins of high molecular weight, alongside free amino acids and peptides as sources of nitrogen.

However, although it is accepted that some micro-organisms are able to assimilate starch or proteins of high molecular weight directly, for their own growth and for the production of economically viable metabolites, because they have the necessary enzymatic equipment to degrade them, other micro-organisms require conditions in which the carbon and hydrogen sources are treated so that they can be assimilated directly.

Wheat solubles, for example, come from the separation flow of B wheat starches resulting from starch separation in the wet wheat starch production process. The B starch, also known as the second starch, consists essentially of a preponderant proportion of small or damaged grains of starch, and contains impurities such as pentosans, proteins and lipids.

These impurities, some of which escape elimination by conventional purification and demineralisation processes, are found in the hydrolysates of these starches and therefore make the B starch unsuitable for manufacturing food grade dextrose, for example. These kinds of B starch are therefore difficult to find industrial outlets for.

The applicant company recommends heating them to a temperature of at least 60° C. and treating them with an α-amylase and a glucoamylase to release from them sugars than can be fermented (see below).

For corn steep liquor, taken directly from corn steeping silos, which have a dry material content from approximately 9% to approximately 10%, the drawback of the 35 wt. % to 40 wt. % of proteins, the essential component of the steep liquor, is that it is difficult to assimilate.

The applicant company has shown that these proteins can be treated using proteolytic enzymes chosen from the group consisting of alkaline proteases and under conditions of pH and temperature that make these proteins easier to metabolise in the subsequent fermentation step. Treatment for approximately 6 hours at a rate of 1%/dry, a pH of 7 and a temperature of 60° C. can advantageously be employed.

In a second embodiment of the process according to the invention a renewable raw material is chosen from the group consisting of by-products of processing milk, barley, soya, sugar cane, sugar beet, alone or in combination.

For example, to produce L-lactic acid, it is advantageous to choose by-products from processing milk, more particularly lactoserum, and by-products from processing sugar beet, more particularly molasses.

Here the renewable raw materials used contain carbon sources more easily assimilated by most micro-organisms.

Thus sugar beet molasses essentially contain saccharose as a source of carbon that can be directly assimilated by the micro-organisms producing lactic acid, for example.

In the same way, lactose, the essential sugary component of lactoserum, is easily assimilated.

However, these proteins are difficult to assimilate for some micro-organisms.

In the case of using by-products of processing milk for producing lactic acid, for example, it can therefore be advantageous to perform proteolysis of the original by-product from milk containing lactose before the treatment with micro-organisms.

The proteolysis step forms peptides which have an activating effect on the micro-organisms producing lactic acid.

The starting material from milk containing the lactose can be a mild or acid lactoserum, for example, a permeate from ultrafiltration of lactoserum, lactose, lactose crystallisation source liquor, and these starting materials can further contain seric proteins or casein.

The proteases that can be used for the proteolysis are chosen from the group comprising pancreatin, trypsin, chymotrypsin, papain, etc.

Depending on the renewable raw material chosen, it may then be necessary to eliminate insoluble impurities of high molecular weight from said raw material enriched in this way with carbon or nitrogen sources which can be directly assimilated.

The insoluble impurities can be mostly fibres.

For example, insolubles are advantageously separated for wheat solubles treated with enzymes for liquefying or saccharifying starch by any technique known to the skilled person, such as centrifuging and microfiltration, alone or in combination, as described later.

The second step of the process according to the invention, which constitutes one of its essential features, consists of treating the raw material to eliminate from it mostly impurities of low molecular weight, without degrading the concentration of carbon sources which can be directly assimilated, using a technique chosen from the group consisting of nanofiltration and electrodialysis, alone or in combination.

The applicant company has thereby overcome a technical prejudice to the effect that nanofiltration and/or electrodialysis must be effected on the lactic acid production medium at the end of fermentation, not on the fermentation medium itself, before inoculating it with the micro-organisms.

Fermentation media based on renewable raw materials contain a number of “low molecular weight impurities”, i.e. (in the context of the invention) small molecules which impede subsequent steps of purifying metabolites produced from said fermentation media.

The small molecules can be sugary residues, for example, that cannot be assimilated by the micro-organisms, such as C5 sugars, which therefore pollute the fermentation medium.

They can equally be organic acids, such as racemic D- and L-lactic acid, which in the case of producing lactic acid as the economically viable metabolite prevents easy recovery of optically pure lactic acid.

The techniques conventionally employed for eliminating these small molecules are known to the skilled person and consist of membrane filtration techniques, for example, or conventional electrodialysis matched to the range of sizes of said low molecular weight impurities.

However, the skilled person does not usually adopt the above technical solutions for treating fermentation media because the cut-off thresholds also lead to the elimination of carbon sources which can be directly assimilated by the micro-organisms and whose size is within the range of sizes of the impurities.

As already mentioned, all the above techniques are in fact already used on the fermentation medium, but only at the end of fermentation.

The applicant company has therefore shown, in contrast to what is regarded as the norm in the literature, that these membrane filtration techniques, and more particularly nanofiltration, or conventional electrodialysis techniques can eliminate low molecular weight impurities and, surprisingly and unexpectedly, can do so without degrading the concentration of carbon sources that can be directly assimilated by the micro-organisms.

Research carried out by the applicant company has led it to establish conditions for application of the above techniques enabling the desired result to be achieved.

For example, for producing lactic acid from wheat solubles, the applicant company has shown that all of the carbon source can be preserved intact after nanofiltration and virtually all of the racemic D- and L-lactic acid can be eliminated for values from 2% to 10%, preferably of the order of 4%, of the dry material prepared from the filtrate of microfiltration in accordance with the first two steps of the process according to the invention, as described below.

For example, for producing lactic acid from corn steep liquor treated with alkaline proteases, as in the first steps of the process according to the invention, treatment to obtain from 1% to 16% dry material, and preferably of the order of 2%, and conventional electrodialysis treatment, as described later, also eliminate virtually all the racemic mixture of D- and L-lactic acid without modifying the concentration of carbon sources that can be directly assimilated.

The third step of the process according to the invention consists of treating the raw material from which low molecular weight impurities have been removed in this way to top up the carbon or nitrogen sources that can be directly assimilated by the micro-organisms.

The nitrogen sources of the renewable raw material from which the impurities have been removed in this way can be topped up after the nanofiltration step, for example.

In the case of wheat solubles, the retentate from nanofiltration is treated with an ALCALASE® alkaline protease from NOVO, as described below, to release the peptides from it.

In the case of corn steep liquor, an additional carbon source can be provided by glucose or by a renewable raw material treated by the process according to the invention.

The final step of the process according to the invention consists of recovering the renewable raw material converted in this way and using it directly as a fermentation medium.

Enrichment with carbon and nitrogen sources that can be directly assimilated and elimination of insoluble impurities and low molecular weight impurities by inexpensive techniques of separation on nanofiltration membranes or in a conventional electrodialysis module therefore produces a medium that is entirely suitable for producing economically viable metabolites, and even for producing populations of micro-organisms from which impurities have been removed.

In the particular case of producing organic acids, and more particularly L-lactic acid, obtaining optically pure lactic acid satisfying pharmaceutical purity standards (the thermal stability test of the “United States Pharmacopeia”) and conforming with the standards of the “Food Chemicals Codex” would therefore require no more than a limited number of purification steps.

Other features and advantages of the invention will become apparent on reading the following illustrative and non-limiting examples.

### EXAMPLE 1

Wheat solubles with 4% dry material from the separation flow of “B” wheat starches were heated to 60° C. for 15 hours and treated with TERMAMYL LC α-amylase from NOVO at the rate of 0.05%/dry and OPTIDEX L 300 A amyloglucosidase from GENENCOR at the rate of 1%/dry to release fermentable sugars. The insolubles were eliminated by microfiltration on a 0.14 μm membrane.

The filtrate obtained, with 3.3% dry material, had the composition set out in Table I below.

TABLE I

| Component | Weight % |
|---|---|
| Glucose | 40 |
| Fructose | 10 |
| Hemicellulose | 17 |
| Proteins | 15 |
| D- and L-lactic acid | 10 |
| Salts and fats | 8 |

The microfiltration filtrate was then nanofiltered on a 2.5 m² EURODIA pilot module fitted with DL 2540 nanofiltration membranes at a pressure of the order of 20 bars; the temperature was regulated to 30° C by external cooling. The permeate contained 0.3% dry material and was principally made up of 1 g/l of D- and L-lactic acid and of the order of 1 g/l of C5 sugars (xylose and arabinose).

The retentate, after concentration by nanofiltration with a factor of 4.5, contained 16% dry material and had the composition set out in Table II below.

TABLE II

| Component | Weight % |
|---|---|
| Glucose | 43 |
| Fructose | 10 |
| Hemicellulose | 20 |
| Proteins | 18 |
| D- and L-lactic acid | 2 |
| Salts and fats | 6 |

This step also eliminated significant racemic D- and L-lactic acid from the wheat solubles.

The intention is for the hemicellulose to be eliminated at the end of fermentation, with the biomass, but it can advantageously be hydrolysed before the nanofiltration step using endo- and exo-xylanases known to the skilled person.

The nanofiltration step can be followed by treatment with proteases under the following conditions, to release the peptides necessary to constitute the nitrogen source of the fermentation medium which can be directly assimilated. No addition of peptides of external origin is therefore necessary in this case.

The pH was adjusted to 7 and the temperature to 60° C. ALCALASE® protease from NOVO was added at the rate of 1%/dry and incubated at 60° C. for 4 hours.

After this step of hydrolysis with proteases, the medium was sterilised by heating to 120° C. for 10 minutes, after which it could be used directly as fermentation medium.

Table III below sets out the composition in terms of D- and L-lactic acid obtained in a fermenter with a usable volume of 15 l containing 13 l of wheat solubles with 16% dry materials, treated and untreated.

1.5 l of medium consisting of a 7-hour preculture of a strain of Lactococcus lactis were used to inoculate these fermenters.

The pH was set at 6.5 and was regulated with 12N NH₄OH. The temperature was 40° C.

TABLE III

| | | Fermentation | L-lactic | D-lactic |
|---|---|---|---|---|
| Nano- | ALCALASE ® | time (h) up | acid | acid |
| filtration | treatment | to Glc = 0 | (g/l) | (g/l) |
| No | Yes | 12 | 59 | 2.8 |
| Yes | No | 50 | 59 | 0.5 |
| Yes | Yes | 12 | 60 | 0.5 |

Thus with a medium pretreated by nanofiltration the final composition of the fermentation medium showed only traces of D-lactic acid.

The wheat solubles treated as above can therefore ensure efficient fermentation into L-lactic acid, with no significant quantities of impurities that could impede its subsequent purification.

Also, much higher productivity was obtained when the medium was pretreated with ALCALASE®.

### EXAMPLE 2

Corn steep liquor taken from an intermediate corn steeping silo with 3.3% dry material had the composition set out in Table IV below.

| Component | Weight % |
|---|---|
| Total sugars | 3 |
| Proteins | 38 |
| D- and L-lactic acid | 32 |
| Salts and miscellaneous | 27 |

Because corn proteins are difficult to assimilate, pre-treatment was carried out with 1%/dry of ALCALASE® from NOVO at pH 7 and 60° C. for 6 hours.

The hydrolysate obtained in this way was then treated by conventional electrodialysis in a EURODIA EUR6B electrodialysis module fitted with CMX-S cationic and AMX SB anionic ion exchange membranes from NEOSEPTA-TOKUYAMA SODA with an active surface area of 5.6 m², in accordance with the specifications of the manufacturer, which produced a fraction diluted to 2% dry material and having the composition set out in Table V below.

TABLE V

| Component | Weight % |
|---|---|
| Total sugars | 4 |
| Hydrolised proteins | 51 |
| D- and L-lactic acid | 3 |
| Salts and miscellaneous | 42 |

Pretreatment with ALCALASE® and elimination of amino acids by conventional electrodialysis provided a corn protein hydrolysate with a degree of hydrolysis at the start of fermentation of 44, as determined by the ratio of aminated nitrogen to total nitrogen, compared to 36 for the untreated liquor.

Table VI below shows the compositions in terms of D- and L-lactic acid obtained in a fermenter with a usable volume of 15 l containing 8.8 l of corn steep liquor with 2% dry materials, treated and untreated, to which 60 g/l of glucose was added as a source of carbon which can be directly assimilated.

1.5 l of medium consisting of a 7-hour preculture of a strain of Lactococcus lactis were used to inoculate these fermenters.

The pH was set at 6.5 and was regulated with 12N NH₄OH. The temperature was 40° C.

TABLE VI

| | | Fermentation | L-lactic | D-lactic |
|---|---|---|---|---|
| Electro- | ALCALASE ® | time (h) up | acid | acid |
| dialysis | treatment | to Glc = 0 | (g/l) | (g/l) |
| No | No | 18 | 62 | 3.3 |
| Yes | No | 18 | 59 | 0.2 |
| Yes | Yes | 15 | 59 | 0.2 |

The steep liquor pretreated by electrodialysis therefore ensured efficient fermentation into lactic acid, again free of significant quantities of impurities that would otherwise impede its subsequent purification. The productivity was again improved by pretreating the fermentation medium with ALCALASE®.

### EXAMPLE 3

Concentrated sugar beet molasses, rediluted to 10% dry material, was treated by conventional electrodialysis under the same conditions as example 2.

The composition of the dry material of the product before electrodialysis was as set out in Table VII below.

TABLE VII

| Component | Weight % | |
|---|---|---|
| Sugars (saccharose) | 66 | (95) |
| Proteins | 14 | |
| Ash | 12 | |
| Organic acids | 4 | |
| Miscellaneous (include betaine) | 4 | |

The electrodialysis step produced a solution with 5.3% dry material in which the richness in sugar was more than 70% and the protein content of the order of 16%.

Thus more than 90% of undesirable organic acids were eliminated from the fermentation medium.

### EXAMPLE 4

Lactoserum was treated by conventional electrodialysis under the same conditions as example 2.

The initial composition of the lactoserum with 6.6% dry material was as set out in Table VIII below.

TABLE VIII

| Component | Weight % |
|---|---|
| Sugars | 71 |
| Proteins | 12 |
| Organic acids | 4 |
| Salts | 9 |
| Fats | 4 |

The conventional electrodialysis step produced a solution with 4.3% dry material.

The richness in sugars was more than 80%, for a protein content of the order of 14%.

All polluting organic acids were eliminated from the medium.

1. A process for preparing a fermentation medium for producing high-purity metabolites from a renewable raw material, which consists of:
a) optionally, treating said renewable raw material to enrich it with carbon or nitrogen sources which can be directly assimilated by micro-organisms and to eliminate insoluble impurities,
b) using a technique chosen from the group consisting of nanofiltration and electrodialysis, alone or in combination, to eliminate low molecular weight impurities from said renewable raw material without degrading its concentration of carbon sources which can be directly assimilated,
c) treating the raw material from which the low molecular weight impurities have been eliminated in this way to top it up with nitrogen or carbon sources which can be directly assimilated by the micro-organisms, and
d) recovering the fermentation medium obtained in this way.

2. A process according to claim 1, wherein the metabolite produced by fermentation is chosen from the group consisting of organic acids, vitamins, amino acids and antibiotics, and is preferably an organic acid.

3. A process according to claim 2, wherein the organic acid is optically pure L-lactic acid.

4. A process according to claim 1, wherein the renewable material is chosen from the group consisting of by-products of starch manufacture, preferably by-products of manufacture of starch from wheat, corn, cassava, potato, or by-products of processing barley, peas, and preferably consists of wheat solubles or corn steep liquor.

5. A process according to claim 1, wherein the renewable material is chosen from the group consisting of by-products from processing milk, soya, sugar cane, sugar beet, and preferably consists of lactoserum and molasses.

6. A process according to claim 1, wherein the renewable raw material is enriched with carbonated sources which can be assimilated by micro-organisms using enzymes for liquefying and saccharifying starch.

7. A process according to claim 1, wherein proteolytic enzymes chosen from the group consisting of alkaline proteases are used to enriched or top up the renewable raw material with nitrogen sources which can be assimilated.

8. A process according to claim 1, wherein glucose is added to top up the renewable raw material with carbon sources which can be assimilated.

9. A fermentation medium obtainable by a process according to claim 1.

10. Process for producing populations of micro-organisms, wherein said populations are produced by fermentation on or in the fermentation medium of claim 9.
